(19) United States
(12) Patent Application Publication
(10) Pub. No.: US 2005/0140105 A1
(43) Pub. Date: Jun. 30, 2005

(54) Jog stroller with steerable front wheel

(75) Inventor: Alfred Hernandez, Pipe Creek, TX (US)

Correspondence Address: KAMMER BROWNING PLLC, 7700 BROADWAY, SUITE 202, SAN ANTONIO, TX, 78209, US

(73) Assignee: ENCUENTA DESIGNS, L.L.C.

(21) Appl. No.: 10/748,954

(22) Filed: Dec. 30, 2003

(51) Int. Cl. B62D 61/06

(52) U.S. Cl. 280/62

(57) ABSTRACT

An improved jogging stroller with at least one castered front wheel that in one configuration is allowed to freely rotate side-to-side and in a second configuration is fixed in a forward direction. A spring-loaded pin is positioned to engage or disengage an indexed aperture so as to release or fix the motion of the castered wheel. The pin is remotely activated by a hand release mechanism positioned on or near the handle of the jogging stroller and is connected to the castered wheel by means of a control cable. The user may alternate between a freely moving caster wheel that facilitates steering and a fixing of the front caster wheel for more stability. The user may lock the system in either the fixed (in-line) configuration or in the freely rotating configuration.

### BACKGROUND OF THE INVENTION

1. Field of Invention

The present invention relates generally to wheeled strollers for babies and young children. The present invention relates more specifically to a jogging stroller having a self-centering, self-locking, steerable front wheel that is alternately remotely lockable in-line.

2. Description of the Prior Art

Wheeled strollers for the transport of babies and young children are well known in the art. A variety of designs include three, four or more wheel sets to facilitate the motion of the stroller. A basic “smooth road” stroller utilizes wheels alone or in wheels sets that are on the order of 5-20 cm in diameter. Strollers with such small wheels are suitable only for smooth terrain as the small diameter of the wheel prohibits easy rotation of the wheel on rough surfaces such as those involving rocks, stones and uneven ground. Such “smooth road” strollers, however, have had the advantage of permitting the use of caster wheels on the front, or in some instances all of the wheel sets, in a manner that permits easy steering of the stroller. The most efficient design for such smooth road steerable strollers has come to be a stroller with four sets of two wheels with the two wheel sets in the front being on casters to permit steering of the stroller.

One additional assumption made in the design and construction of smooth road strollers is that the forward motion of the stroller is relatively slow. Difficulties arise with the small diameter wheel design when the speed of motion increases and even a small obstacle is encountered on the otherwise smooth terrain. Jogging strollers have been developed for use by those who intend to travel with a stroller at a higher rate of speed. Larger wheel diameters are dictated by this higher rate of speed over what might potentially be modestly uneven terrain. The larger wheel design, as is well known in the art, allows for greater stability over uneven terrain and upon encountering minor obstacles such as small stones and sticks. Most current jogging stroller designs, therefore, have wheel diameters in excess of 20 cm on up to “bicycle size” 70-80 cm diameter wheels. These larger diameter wheels solve some of the problems associated with the safe transport of a stroller vehicle at a greater motion speed.

The ability to steer a jogging stroller has generally been addressed by eliminating one of the two front wheel sets from the standard “smooth road” stroller described above. A three-wheeled stroller, even with an in-line fixed front wheel, is significantly easier to steer than a four-wheeled stroller having the same diameter wheel sets. In addition, three point contact is more stable than four (or more) on uneven terrain as all three points will generally remain in contact with the ground. A four wheel device will tend to lose contact with the ground at one wheel when traveling over uneven terrain. While the front wheel of a three-wheeled stroller more than adequately supports the front frame of the stroller, it provides only one road or terrain surface contact point rather than two. As it is the front wheel that will typically encounter an obstacle first in the path of the stroller, this single front wheel configuration significantly reduces the difficulties associated with encountering even small obstacles in the path.

Jogging strollers of the above described three-wheel design have generally not incorporated front wheel sets on casters because of the tendency for caster wheels to be thrown sideways upon encountering an obstacle in a manner that could serve to turn the stroller over due to the forward momentum. On the other hand, on relatively smooth terrain, a castered front wheel makes steering the stroller much easier and eliminates the need to lift the front wheel off of the ground to effect a turn. With jogging strollers, therefore, there are advantages to having a fixed front wheel in that the danger of the wheel turning sideway when encountering an obstacle is eliminated. The disadvantage of such an arrangement is the difficulty associated with steering the jogging stroller with a fixed front wheel. A castered front wheel has the advantage of being easily steerable and the disadvantage of being turned sideways upon encountering an obstacle. Wheeled strollers have generally been designed only to solve one of the two problems; namely, to either provide efficient steering through the use of a castered wheel, or to provide stable motion through the use of an in-line fixed front wheel.

Various attempts have been made in the prior art to accommodate and resolve both of the above identified problems. The following are representative of some of the more recent efforts in this regard.

U.S. Pat. No. 5,191,675 issued to Ishikura on Mar. 9, 1993 entitled CASTER MECHANISM FOR CARRIAGE. This patent describes a caster wheel mechanism for a carriage that incorporates a foot actuated mechanism for fixing the direction of the carriage wheel.

U.S. Pat. No. 5,983,614 issued to Hancock et al. on Nov. 16, 1999 entitled LOCKABLE FRONT WHEEL SWIVEL FOR LAWN MOWERS. This patent describes a castered wheel for a lawn mower that utilizes a locking bracket operable by a control cable to engage the swivel axle of the castered wheel.

U.S. Pat. No. 4,028,773 issued to Morgan on Jun. 14, 1977 entitled SWIVEL CASTER. This patent discloses a swivel caster wheel having an indexed cam on which rides a spring actuated pin that will fix the caster in one of four rotational positions. A pull ring is positioned on the spring actuated pin to release the caster wheel from one of the fixed positions.

U.S. Pat. No. 4,349,938 issued to Fontana on Sep. 21, 1982 entitled CASTER ASSEMBLY WITH SWIVEL LOCK. This patent describes a caster wheel assembly having a retractable spring loaded pin positioned on the wheel fork itself that rotates in conjunction with the wheel. The pin engages a fixed cam with indexed indentations similar to the above-referenced Morgan disclosure. Again, a ring is fixed to the end of the spring-loaded pin to facilitate its retraction from the indentations in the cam in a manner that permits rotational movement of the caster.

U.S. Pat. No. 5,029,886 issued to Takahashi et al. on Jul. 9, 1991 entitled STEERING APPARATUS FOR BABY CARRIAGE. This patent describes a stroller with four wheel sets, two in the front and two in the back, wherein the back wheel sets can alternately be made fixed or steerable. A specific rear axle design permits the alternate use of the stroller in a two-wheel or four-wheel steerable configuration.

U.S. Pat. No. 6,494,469 issued to Hara et al. on Dec. 17, 2002 entitled ROLLING WALKER. This patent describes a four-wheel set walker for an adult that incorporates small stroller sized wheels that include casters on both the front and rear wheel sets. The walker incorporates mechanisms for fixing the front casters by means of a foot lever operable at the caster wheel. The rear casters are fixed.

U.S. Pat. No. 6,557,870 issued to Cheng on May 6, 2003 entitled MEANS FOR LIMITING DIRECTION OF A STROLLER FRONT WHEEL. This patent describes a foot operated mechanism for locking the front caster wheel of a stroller. An engagement gap is described to receive an engaging tab when a foot lever directs the engaging tab to move into the gap.

U.S. Pat. No. 4,336,629 issued to Jarvis, Jr. et al. on Jun. 29, 1982 entitled CASTER SWIVEL LOCK. This patent describes a pin-in-slot locking caster wheel that is operated locally at the wheel by means of a foot lever. The engagement structure involves a retractable pin that, when the caster wheel is appropriately oriented, engages a slot.

U.S. Pat. No. 4,309,791 issued to Aulik on Jan. 12, 1982 entitled CASTER BRAKE AND SWIVEL LOCK FOR STRETCHER OR THE LIKE. This patent also describes a foot operated mechanism for positioning a pin in a plate hole for the locking of swivel casters on a moveable hospital bed. A pin is alternately lowered or lifted from a hole in a disc that rotates in conjunction with each of the caster wheels.

U.S. Pat. No. 6,402,166 issued to Chiu on Jun. 11, 2002 entitled LOCKING DEVICE FOR LIMITING SWIVELING MOVEMENT OF A FRONT WHEEL OF A STROLLER. This patent describes a three-wheeled stroller with a locally operated locking front caster that positions a pin through a fork tube. This patent involves no remote locking or release mechanism and does require stopping the stroller to activate or deactivate the fixing of the front caster wheel.

U.S. Pat. No. 5,669,624 issued to Eichhorn on Sep. 23, 1997 entitled STROLLER. This patent also describes a three-wheeled stroller with an alternately lockable or releasable front caster wheel. In this instance a rigid pin is fixed on the shaft of the caster wheel and may ultimately engage or disengage a slot formed in a hand actuated block. This results in a caster wheel that is non-self centering and which requires stopping to switch between a lock and an unlocked swivel position.

U.S. Pat. No. 4,759,098 issued to Ko on Jul. 26, 1988 entitled DIRECTION SETTING DEVICE FOR ROLLERS OF A BABY WALKER. This patent describes a pair of front wheels for a stroller that include caster wheel structures having key member and key way engagement elements that allow the fixing of the front wheels in a forward direction. Foot actuated engagement and release mechanisms are described.

It would be desirable to provide a jogging stroller that addresses both the problems associated with ease of steering and the danger of sudden sideways rotation of a castered wheel upon encountering an obstacle. It would be desirable to provide a mechanism for switching between fixed front wheels and moveable front wheels in a manner that is remote from the wheels themselves and operable while the stroller is in forward motion. As such problems are generally not adequately addressed in the prior art, it would be desirable to provide a system that permits the user to remotely switch between solutions that address the steering problem and solutions that address the stability problem.

### SUMMARY OF INVENTION

It is therefore an object of the present invention to provide an improved jogging stroller that incorporates a castered front wheel to permit steering of the stroller on generally even terrain.

It is a further object of the present invention to provide an improved jogging stroller having a castered front wheel set that permits the fixing of the direction of the castered front wheel in line with the direction of travel to provide stability upon encountering obstacles in the terrain of travel.

It is a further object of the present invention to provide an improved jogging stroller having a castered front wheel set that may be alternately switched between a freely rotating configuration that permits steering of the stroller and a fixed in-line orientation that affords greater stability to the stroller.

It is a further object of the present invention to provide an improved jogging stroller having a castered front wheel set that allows the user to remotely activate a mechanism to switch the front wheel set from a rotatable/steerable configuration to a fixed in-line stable configuration.

In fulfillment of the above and other objectives, the present invention provides an improved jogging stroller having at least one castered front wheel set that in one configuration is allowed to freely rotate to permit steering of the stroller and in a second configuration is fixed in a forward direction to increase the stability of the stroller. An indexed cam is positioned on the castered front wheel assembly and a spring-loaded pin is positioned to engage or disengage the indexed cam so as to fix or release the rotational motion of the castered wheel. The spring-loaded pin used for fixing or releasing the caster wheel is remotely activated by a hand release mechanism positioned on the jogging stroller within reach of the user. The release mechanism is connected to the castered wheel by means of a co-axially encased sliding cable. The structure of the invention allows the user to alternate between a freely moving caster wheel that facilitates steering of the stroller over relatively smooth terrain and the fixing of the front caster wheel for more stable movement over uneven terrain. The structure of the invention further allows the user to remotely switch between a freely moving caster and a fixed caster without the requirement of stopping the stroller's forward motion and without the need to relinquish normal control over the stroller.

### BRIEF DESCRIPTION OF THE DRAWING

FIG. 1 is a perspective view of the assembled structure of the present invention with the typical fabric sling portion of the stroller removed for clarity.

FIG. 2 is a detailed perspective drawing of the present invention showing the remotely operable spring-loaded release mechanism.

FIG. 3 is a detailed perspective drawing of the hand operated release mechanism of the present invention.

FIGS. 4a and 4b are side and top views respectively of the rotating fork component associated with the front caster wheel of the present invention.

FIGS. 5a and 5b are cross sectional views associated with the structures disclosed in FIGS. 4a and 4b.

FIG. 6 is an exploded view of the assembly of the rotating caster bearing mechanism of the present invention.

### DETAILED DESCRIPTION OF THE PREFERRED EMBODIMENT

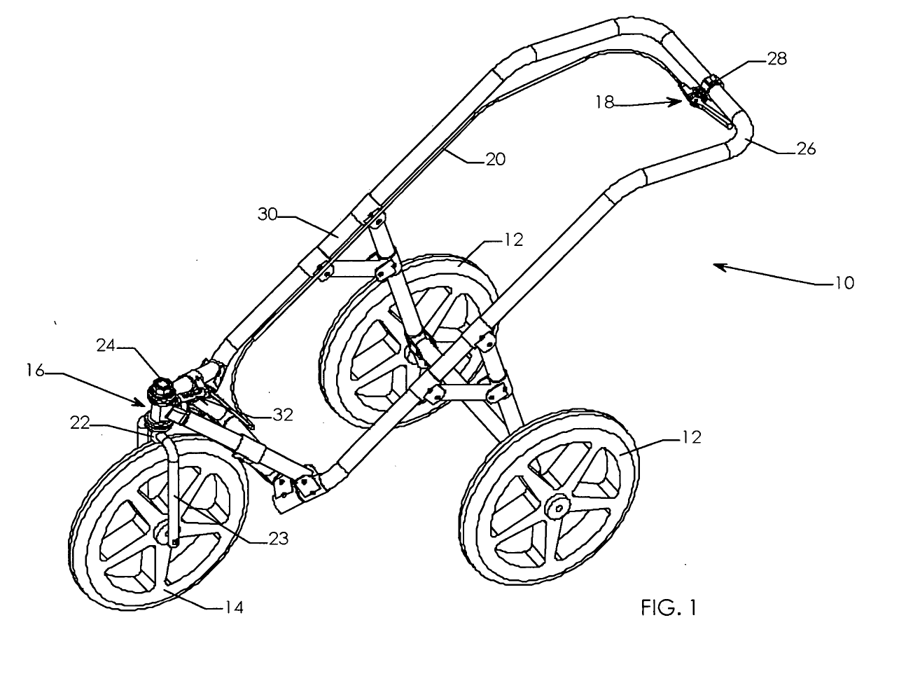

Reference is made first to FIG. 1 for a general description of the overall structure of the system of the present invention and its functional operation. The stroller depicted is one representative possibility for a stroller appropriate for implementing the present invention. Alternative structures are possible and contemplated. FIG. 1 discloses the basic frame of a jogging stroller incorporating three large wheels. The typical fabric sling component of the jogging stroller has been omitted in this view for clarity. Various structures for supporting and holding the baby or young child in the stroller are well known in the art. The basic jogging stroller frame 10 shown in FIG. 1 utilizes two rear wheels 12 and a single front wheel 14 for support and motion. Caster bearing 16 is positioned on the front of stroller frame 10 to support front wheel 14. Caster wheel pivot shaft 22 retains front wheel fork 23 in a manner typical of rotating caster wheels and as is known in the field of three-wheeled strollers. Bearing assembly cover 74 (described in more detail below) secures caster shaft 22 in caster bearing 16 and allows the rotation of front wheel 14 as described in more detail below. Top nut 24 serves as a lock nut to the bearing assembly cover 74. Cover 74 secures the assembly with minimal axial movement while continuing to allow rotation. Top nut 24 is used to keep cover 74 from becoming loose.

Positioned near a top handle portion 26 of stroller frame 10 is hand operated release mechanism 18 of the type utilized in conjunction with bicycle brake systems and the like. Release mechanism 18 is attached to stroller handle 26 by means of clamp assembly 28.

Caster bearing 16 is fixed with retention pin mechanism 32 which serves to alternatively fix or release the rotating motion of pivot shaft 22 within caster bearing 16 as is described in more detail below. Connecting release mechanism 18 with pin mechanism 32 is control cable 20 positioned on a mid section 30 of stroller frame 10.

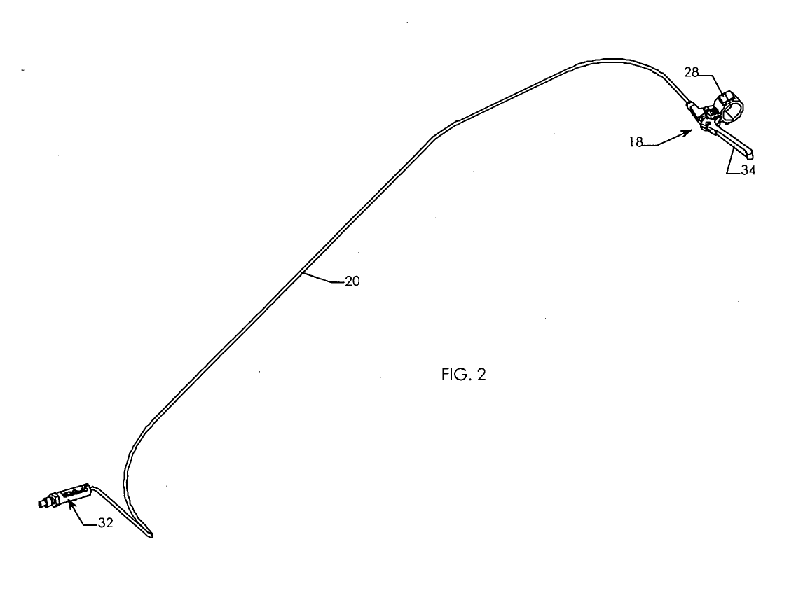

Referring now to FIG. 2, details of the control mechanism of the present invention are shown. Release mechanism 18 is a hand operated control cable device that incorporates hand lever 34 and attachment clamp 28. Release mechanism 18 is connected to retention pin mechanism 32 by means of control cable 20. The structure and function of the control cable system of the present invention is similar in many respects to the structure and function of control cables utilized with bicycles and the like. Release mechanism 18 is positioned within reach of where the operator's hand would normally be located in directing the motion and control of the wheeled vehicle. The user may alternately engage or disengage hand lever 34, which is connected to a co-axially positioned wire cable within control cable 20, and pull or slide the interior cable in a manner that effects a similar motion at a remote end of the control cable. In the present case, the remote end incorporates a spring loaded pin (as described in more detail below) at retention pin mechanism 32 in a manner that either introduces or removes the end of the pin from a receptor aperture in the rotatable caster pivot shaft of the front wheel assembly.

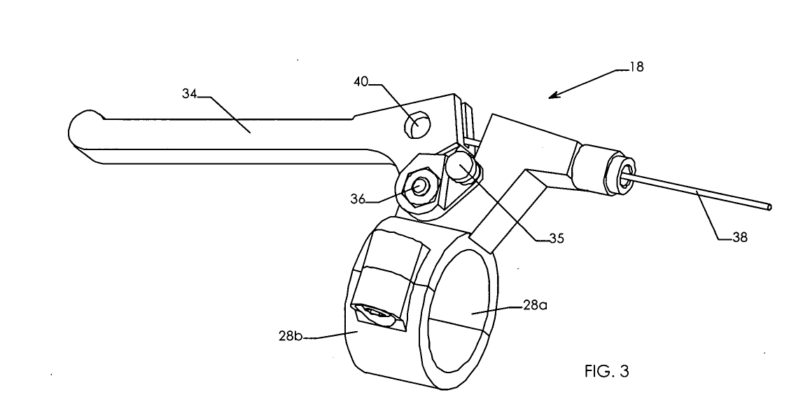

FIG. 3 shows in greater detail the structure of release mechanism 18. As mentioned above, hand lever 34 is attached to an interior wire cable 38 (shown exposed outside of its co-axial enclosure in this view) in a manner that allows linear motion of cable 38 upon levered movement of hand lever 34. Cable 38 is attached to hand lever 34 by means of pin 40. Pivot pin 36 allows for the levered motion of hand lever 34 that affects the linear motion of cable 38. Attachment clamp 28 is comprised of semi-circular cylindrical components 28a and 28b which separate to permit engagement of the handle portion of the stroller as described above. Release mechanism 18 also retains locking means 35 that allows the user to lock the grip in the “closed” position (where the locking pin in the caster wheel is not engaged with the aperture). Locking means 35 is a pin positioned next to pivot pin 36 as shown in FIG. 3. Locking pin 35 is spring biased to an outward and unlocked position. When the user pulls on hand lever 34, locking pin 35 may simultaneously be pushed down against the spring bias and held in such a position while the user releases hand lever 34. The friction between hand lever 34 (at a point not shown) and locking pin 35 cause locking pin 35 to be held in an inward position. This forces hand lever 34 to be retained in an “activated” position that maintains the locking pin (remotely located) out from the locking aperture. To release, the user once again pulls on hand lever 34 and locking pin 35 is released to spring back into an unlocked position.

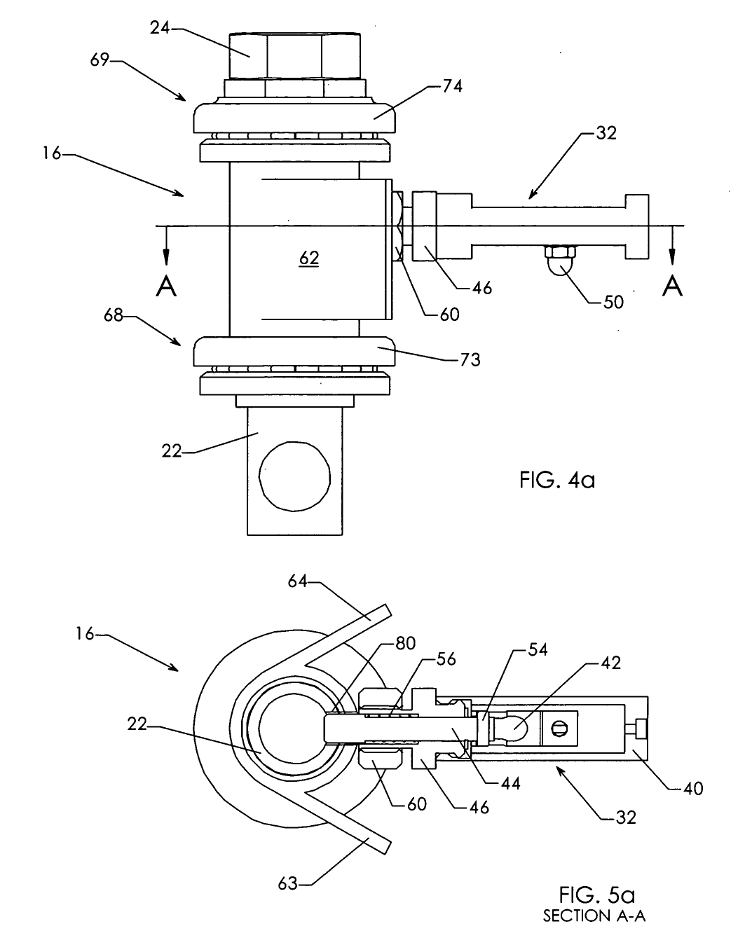

FIGS. 4a and 4b provide external views of the front caster wheel bearing assembly that affects the major functionality of the present invention. FIG. 4a is a side view of caster bearing 16 shown separated from the front wheel fork and from the control cable for clarity. In this view bearing housing 62 serves to position a pair of bearing assemblies 68 and 69 that permit the easy rotation of caster pivot shaft 22 within bearing housing 62. Bearing assembly cover 74 fixes pivot shaft 22 within the bearing assembly. Top nut 24 serves as a lock nut for bearing assembly cover 74. Retention pin mechanism 32 is positioned on and into bearing housing 62 and serves to position and hold the retractable retention pin as described in more detail below. Removable fitting 46 provides the connector for retention pin mechanism 32 to be positioned on bearing housing 62. Removable cap nut 50 is shown where it would be normally positioned after attachment of the control cable to the assembly. It should be noted that the front caster wheel bearing assembly described herein is a relatively straight forward modification of a known bicycle steering headset. This makes implementation of the mechanism of the present invention a relatively low cost endeavor.

FIG. 4b discloses a top view of the same assembly described in FIG. 4a. In this view, caster bearing 16 is shown to be configured with side plates 63 and 64 that serve primarily to facilitate the mounting of the caster assembly to the frame of the stroller and secondarily as partial protection for the placement of retention pin mechanism 32. Threaded fitting 60 is shown where it receives and engages removable fitting 46 for the attachment of retention pin mechanism 32.

Retention pin mechanism 32 comprises a cylindrical frame 40 within which sliding retention pin 44 is positioned. A connector yoke 42 connects retention pin 44 to the control cable (not shown). Bolt 48 serves in conjunction with cap nut 50, referenced above, to retain the control cable on connector yoke 42.

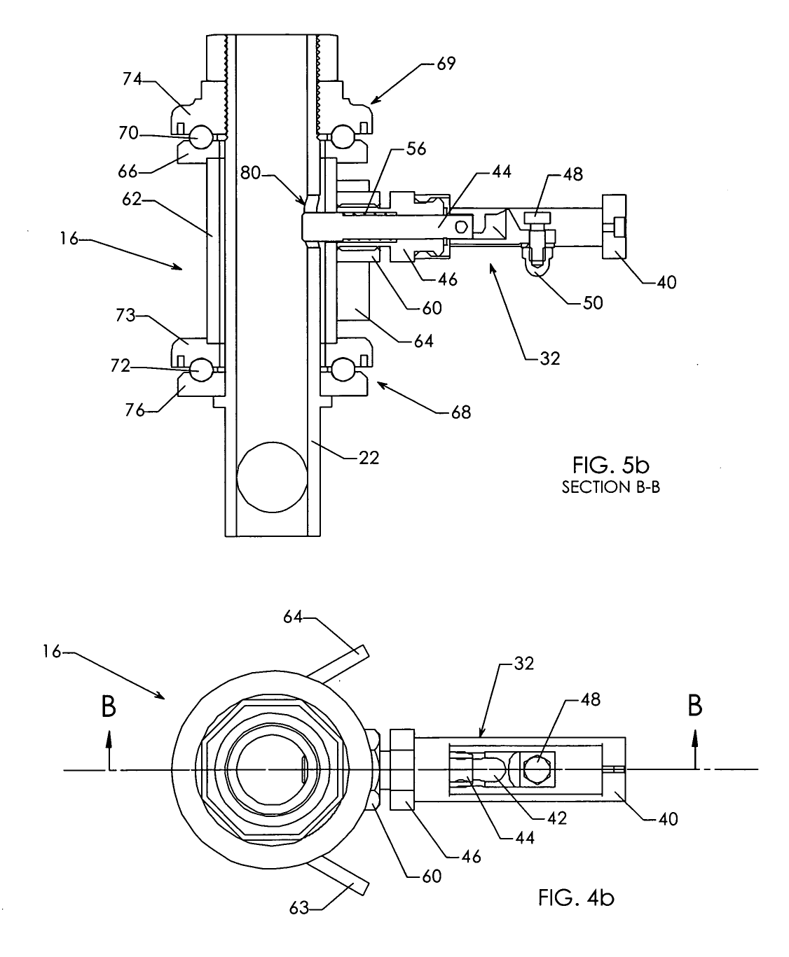

FIGS. 5a and 5b show cross sectional views of the assemblies disclosed above in FIGS. 4a and 4b. 5a represents the cross sectional view along section line A-A shown in FIG. 4a and FIG. 5b shows the cross sectional view taken along section line B-B shown in FIG. 4b. 5a discloses in greater detail the manner in which retention pin 44 may be introduced into and removed from the appropriately positioned aperture in caster wheel pivot shaft 22. In FIG. 5a, spring 56 associated with pin 44 is disclosed. Connector pin 54 is shown extending through one end of retention pin 44 in a manner that allows connector yolk 42 to be attached to retention pin 44. FIG. 5b shows in greater detail the structures of the bearing assemblies 68 and 69 for the caster bearing 16 of the present invention. Caster wheel pivot shaft 22 extends through bearing 16 and is fixed in longitudinal position by means of the aforementioned bearing assemblies. Ball bearing sets 70 and 72 are held captive within bearing assemblies 68 and 69 in conjunction with bearing tracts 66 and 76. In this manner pivot shaft 22 is free to rotate within the assembly but is fixed in its longitudinal position.

Bearing seals have been omitted for clarity in FIGS. 4a, 4b, 5a, 5b and 6. Such bearing seals for bearing assemblies 68 and 69 serve to block out contaminants from the bearing and to seal in bearing lubricant as is known in the art.

Aperture 80 is configured in one location on a wall of pivot shaft 22 in a manner that allows it to receive, when aligned, retention pin 44. In this configuration, retention pin 44 extends through both a fixed aperture in bearing housing 62 and aperture 80 positioned in caster pivot shaft 22. The normal condition effected by spring 56 is to position retention pin 44 in a manner that directs it into aperture 80 and fixes the rotation of caster pivot shaft 22 in a manner that prevents the side to side rotation of the caster wheel. Operation of the control cable associated with retention pin mechanism 32 works against the force of spring 56 to remove retention pin 44 from aperture 80 and thus permit the free rotation of caster pivot shaft 22 within caster bearing 16. As indicated above, bolt 48 in conjunction with cap nut 50 serve to retain the control cable on connector yoke 42. Bolt 48 defines an aperture through which cable 38 is fed. Bolt 48 and nut 50 are thereby used to clamp cable 38 into position in a manner well known in the art.

Aperture 80 described above and shown in the referenced figures is indicated larger than would be appropriate in practice simply for clarity. In practice a tight tolerance in the fit between the pin and the aperture is preferable in order to provide greater rigidity and stability to the front wheel. Thus, the point at which pin 44 contacts the edges of aperture 80 would be less discernable than represented in FIGS. 5a and 5b, for example. In addition, pin 44 could be configured with a much larger chamfer than that shown in the enclosed figures. Additionally, the shape of aperture 80 could be modified to accommodate the specific geometry and configuration of pin 44. Structuring pin 44 with a chamfer as indicated would allow the maintenance of firm engagement between pin 44 and aperture 80 even over time as a wearing down of pin 44 and the edges of aperture 80 might occur. Under such circumstances, pin 44 would simply further engage aperture 80 as a result of the spring bias on the pin so as to continue to maintain the caster assembly rigidly fixed with as little play as possible.

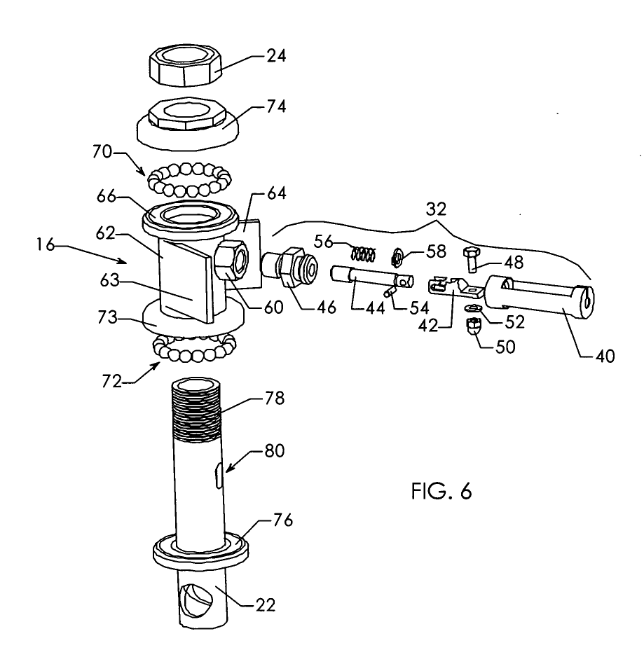

Reference is finally made to FIG. 6 for an exploded detailed view of all of the components associated with the front caster bearing assembly of the present invention. Again, caster pivot shaft 22 is positioned within caster bearing assembly 16 through bearing housing 62. Ball bearing sets 72 and 70 are positioned and secured in ball bearing tracts 66 and 76 and are covered over by bearing assembly covers 73 and 74. The caster pivot shaft 22 is held in place by bearing assembly cover 74 which is threaded onto a threaded portion 78 of caster pivot shaft 22. Aperture 80 is shown as appropriately positioned in caster pivot shaft 22. Bearing assembly cover 74 threads onto pivot shaft 22 but is not secured rigidly tight. This serves to remove undesired movement in the assembly but leaves the caster loose enough to rotate. Top nut 24 serves as a lock nut to keep bearing assembly cover 74 from becoming loose over time.

Threaded fitting 60 is positioned on bearing housing 62 in a manner to receive removable connector 46 that comprises a portion of and positions retention pin assembly 32. Retention pin 44 is fitted with spring 56 so as to urge retention pin 44 towards aperture 80. Connector pin 54 is positioned through one end of retention pin 44 (after placement of washer 58 thereon) in a manner that allows the engagement of connector yoke 42 with retention pin 44. Connector yoke 42 is attached to the sliding cable (not shown) by means of bolt 48, washer 52 and cap nut 50. Once again, bolt 48 retains a passage through it to receive the sliding cable (not shown) and to clamp it in position by tightening cap nut 50. Retention pin 44 and its associated components are enclosed within cylindrical frame 40. The control cable (not shown) enters cylindrical frame 40 at one end thereof where it interiorly engages connector yoke 42 as described above.

Operation of the present invention (reference is again made to FIG. 1) is easily effected by the user's hand engagement of release mechanism 18. As mentioned above, the static condition of the system of the present invention is the spring forced direction of retention pin 44 into aperture 80 on caster pivot shaft 22. This static condition fixes wheel 14 in line with the direction of travel of the stroller. In this condition operation of the stroller in a forward motion retains the stability normally associated with uncastered wheeled strollers. When the user anticipates the need for steering, and likewise anticipates a reduced need for inline stability, he or she may engage the release mechanism 18 by compressing the hand lever thereon and moving the control cable so as to retract retention pin 44 out from aperture 80 in caster pivot shaft 22. This releases caster pivot 22 and allows its free rotational movement. This free rotational movement, as described above, facilitates the steering of the stroller as necessary.

As mentioned above, release mechanism 18 of the present invention is structured so as to allow the compression of the hand lever by the user in order to effect the retraction of retention pin 44 from aperture 80 in a remote fashion. Also as described above, locking pin 35 allows the user to maintain the hand lever in a “closed” position, thus maintaining the retraction of retention pin 44 from aperture 80, in a manner that does not require the continuous grip of the user on the hand lever. The user can then release the grip from a locked position by slightly compressing the hand lever further so as to disengage locking pin 35 from frictional contact with the land lever and then releasing the hand lever to once again allow retention pin 44 to move according to its spring biased configuration.

One advantage provided by the above-described structure of the present invention is the self-centering ability of the caster wheel assembly. If the user activates the pin (remotely) in the middle of a turn at a point where the pin is not aligned with the aperture, the spring biased pin will dispose itself on the surface of the rotating shaft of the caster wheel assembly until such point where the wheel is oriented in-line with a straight forward motion of the stroller. At this point the pin will “find” the aperture and the caster wheel will become locked in that position. The ability to switch between locked and unlocked, as well as between unlocked and locked, on the fly in conjunction with the locking mechanism being self-centering, provides significant advantages to the present invention.

Additionally, it can be seen from the above-described structure, that the pin aperture interface associated with the locking mechanism of the present invention is protected from the elements that are normally encountered in conjunction with three-wheeled jogging strollers and the like. Dirt, sand, grass, and other particulate matter are prohibited from engaging the pin and/or the aperture because of the tight tolerances associated with the enclosures surrounding these elements. The design described inherently protects the interface between the pin and the aperture and is therefore resilient to the effects of the normal use environment.

It should be understood that various other grip and locking mechanisms are readily available and may be utilized in conjunction with the movement and locking of the cable assembly of the present invention. Other spring loaded latches that include ratchet mechanisms and other releasable/lockable mechanisms can be utilized in place of the hand lever mechanism described above in the preferred embodiment. Other such cable motion locking and releasing mechanisms may be utilized in conjunction with the present invention without departing from the spirit of the design.

In addition, various other methods for locking the caster may also be implemented without departing from the basic concept of the present invention. The retention pin may, for example, be positioned parallel to the caster wheel axis of rotation and engage a hole in a plate that is rigidly mounted to the rotating shaft of the caster. Yet another alternate embodiment could include a cam follower mounted on a fulcrum to engage a notch in the cam that is rigidly mounted on the caster wheel shaft. Alternately, a retaining mechanism that clamps over one side or both sides of the fork of the stroller that prevents it from rotating may be implemented in the manner described above in conjunction with the preferred embodiment.

The specific position of the remote activation assembly may also be altered depending upon the design of the stroller and various other factors, again without departing from the scope of the invention. The activation mechanism may, for example, be mounted on one of the side rails of the stroller as long as it is still within the reach of the user during the process of directing the stroller in a forward motion.

Finally, it is noted that in the preferred embodiment described above, there is a bias to have the caster in a locked position as opposed to a free moving state. It is possible to configure the above-described embodiment (by appropriate repositioning of bias springs and the like) to make the preferred bias state of the caster wheel to be the free spinning state. The user may then selectively switch between the free spinning state and the fixed state in the same manner described above with the locked position bias.

A single preferred embodiment of the present invention has been described in the above detailed disclosure. It is anticipated that those skilled in the art will recognize modifications of the above-described preferred embodiment that still fall within the confines of the claims which follow. Although a three-wheeled stroller has been described in the preferred embodiment, the same structures and elements of the invention could easily be incorporated into a stroller that utilizes two front wheel sets instead of a single front wheel set. Likewise, under extreme conditions it is anticipated that the structures and functions of the present invention could operate to effect the release or retention of caster wheels positioned on the rear of a stroller vehicle as well as the front. In addition, a variety of other hand operated release mechanisms may be utilized with the control cable system of the present invention. Each of these alternate embodiments should be seen by those skilled in the art as falling within the scope of the following claims:

1. An improved wheeled carriage having a frame and a plurality of wheel assemblies at least one of which wheel assemblies is a caster wheel assembly, the improvement comprising:
a caster wheel support assembly comprising a rotatable caster pivot shaft, one end of which retains a rotatable wheel and a second end of which extends through a bearing housing, said caster pivot shaft defining radial index aperture positioned on the cylindrical surface of said caster pivots shaft;
a retractable retention piri positioned proximate to said radial index aperture in said caster pivot shaft and alternately movable between a position engaging said aperture and a position removed from said aperture;
a longitudinally moveable control cable mechanically connected to said retractable retention pin; and
a remote release mechanism mechanically connected to a distal end of said control cable in a manner that directs the longitudinal movement of said control cable and thereby the longitudinal movement of said retention pin in a manner that alternately introduces or removes said retention pin from said aperture.

2. The improved wheeled carriage of claim 1 wherein said retention pin further comprises a spring that preferences the retention pin to be introduced into said aperture unless said control cable operates against the force of said spring to remove said retention pin from said aperture.

3. The improved wheeled carriage of claim 1 wherein said remote release mechanism comprises a hand operated lever assembly that by lever motion pulls said control cable in a longitudinal direction that removes said retention pin from said aperture.

4. The improved wheeled carriage of claim 1 wherein said retention pin is positioned proximate to said aperture in said caster pivot shaft and is enclosed within a pin housing attached to said bearing housing, said control cable extending through an aperture in said cylindrical pin housing to its point of mechanical connection with said retention pin.

5. The improved wheeled carriage of claim 1 wherein said remote release mechanism is positioned on a user accessible portion of said wheeled carriage.

6. The improved wheeled carriage of claim 1 wherein said caster wheel support assembly is positioned on a front portion of said wheeled carriage.

7. The improved wheeled carriage of claim 1 wherein said remote release mechanism may be mechanically fixed in an actuated condition such that said retention pin is removed from said aperture without requiring retention of the user's hand on the remote release mechanism.

8. The improved wheeled carriage of claim 1 wherein said retention pin further comprises a spring that preferences the retention pin to be removed from said aperture unless said control cable operates against the force of said spring to introduce said retention pin into said aperture.

9. The improved wheeled carriage of claim 1 wherein said remote release mechanism comprises a hand operated lever assembly that by lever motion pulls said control cable in a longitudinal direction that introduces said retention pin into said aperture.

10. The improved wheeled carriage of claim 1 wherein said remote release mechanism may be mechanically fixed in an actuated condition such that said retention pin is introduced into said aperture without requiring retention of the user's hand on the remote release mechanism.
